(19) United States
(12) Patent Application Publication
(10) Pub. No.: US 2016/0059526 A1
(43) Pub. Date: Mar. 3, 2016

(54) SURFACE COVERING WITH WEAR LAYER HAVING DISPERSED WEAR RESISTANT PARTICLES AND METHOD OF MAKING THE SAME

(71) Applicant: ARMSTRONG WORLD INDUSTRIES, INC., Lancaster, PA (US)

(72) Inventors: ROBERT C. LAUSCH, Lititz, PA (US); CHARLES HESS, Gordonsville, VA (US)

(21) Appl. No.: 14/935,046

(22) Filed: Nov. 6, 2015

Related U.S. Application Data
(63) Continuation of application No. 12/566,118, filed on Sep. 24, 2009, now abandoned.

(51) Int. Cl. B32B 27/18; B32B 33/00; B32B 37/00; B32B 7/02; B29D 7/01; B32B 27/30; B32B 37/15

(52) U.S. Cl. CPC B32B 27/18; B32B 27/30; B32B 33/00; B32B 37/153; B32B 7/02; B29D 7/01; B32B 37/156; B32B 2305/30; B32B 2307/554; B32B 2471/00; B29K 2023/00

(57) ABSTRACT

A surface covering includes a base layer, a wear layer, and a topcoat layer. The wear layer is laminated to the base layer. The wear layer comprises a polymeric binder system having wear resistant particles dispersed therein. The wear layer is formed by dispersing a plurality of wear resistant particles into a liquid to form a stable liquid dispersion, blending the stable liquid dispersion into a polymeric resin to form a mixture, and extruding the mixture to form the wear layer.

### CROSS-REFERENCE TO RELATED APPLICATIONS

This application is a continuation of U.S. patent application Ser. No. 12/566,118 filed on Sep. 24, 2009. The disclosure of the above application is incorporated herein by reference.

### FIELD OF THE INVENTION

The present invention relates to a surface covering with a wear layer having dispersed wear resistant particles and a method of making the same.

### BACKGROUND OF THE INVENTION

In order to improve wear, surface coverings are often provided with a topcoat on an outermost surface thereof. Conventional topcoats typically consist of radiation curable coatings, such as ultraviolet curable coatings. The radiation curable coatings are typically resin based mixtures of oligomers or monomers that are cured or cross-linked after being applied to the surface covering by radiation curing. The radiation curing polymerizes the resins to produce a high or low gloss coating having superior abrasion and chemical resistance properties. In order to further enhance the properties of the topcoat, the topcoat may also be provided with wear resistant particles, such as aluminum oxide, which are dispersed throughout the coating.

Because the above-described topcoat is typically applied and cured after the surface covering has been fully constructed, the application and curing of the topcoat requires additional processing steps after the surface covering has been constructed. Additionally, curing the topcoat with UV lamps incurs extra cost. Further, the uniqueness of the chemistry of the topcoat, particularly when dispersed with the wear resistance particles, requires extra blending and curing steps. These additional steps can result in increased costs as well as increases in material loss due to extra handling of the surface covering. It therefore desirable to develop a surface covering having an outermost surface with added abrasion and chemical resistance properties that can be easily constructed so that unnecessary processing steps can be eliminated and costs can be reduced.

### BRIEF SUMMARY OF THE INVENTION

The invention is directed to a surface covering comprising a first major surface opposite a second major surface, the surface covering further comprising a laminate structure comprising: a base layer; a wear layer atop the base layer, the wear layer having a first thickness as measured from an upper surface to a lower surface of the wear layer, the wear layer comprising a polymeric binder and wear resistance particles dispersed in the polymer binder; a topcoat layer atop the wear layer, the topcoat layer having a second thickness as measured from an upper surface to a lower surface of the topcoat layer; and wherein the wear resistance particles are offset from the first major surface of the surface covering by a distance of at least the second thickness of the topcoat layer.

Other embodiments of the present invention are directed to a process for forming a surface covering comprising: mixing together polymeric binder and wear resistant particles to form a wear composition; forming a film from the wear composition; and applying the film to a base layer; wherein the film is formed by at least one of extruding or calendering the wear composition into the film.

Other embodiments of the present invention are directed to a surface covering comprising a laminate structure comprising: a base layer having an upper surface opposite a lower surface; a wear layer atop the base layer, the wear layer comprising a polymeric binder and wear resistance particles; and a topcoat layer atop the wear layer, the topcoat layer being a continuous layer and being substantially free of the wear resistant particles.

### BRIEF DESCRIPTION OF THE DRAWINGS

FIG. 1 is a schematic illustration of a surface covering according to an embodiment of the invention;

FIG. 2 is a schematic illustration of an alternate embodiment of the invention showing the surface covering with a topcoat;

FIG. 3 is a schematic illustration of a further alternate embodiment of the invention showing the surface covering with a print layer having an ink pattern on a back surface thereof; and

FIG. 4 is a schematic illustration of a still further alternate embodiment of the invention showing the surface covering with a print layer having an ink pattern on a top surface thereof.

### DETAILED DESCRIPTION OF THE EMBODIMENT(S)

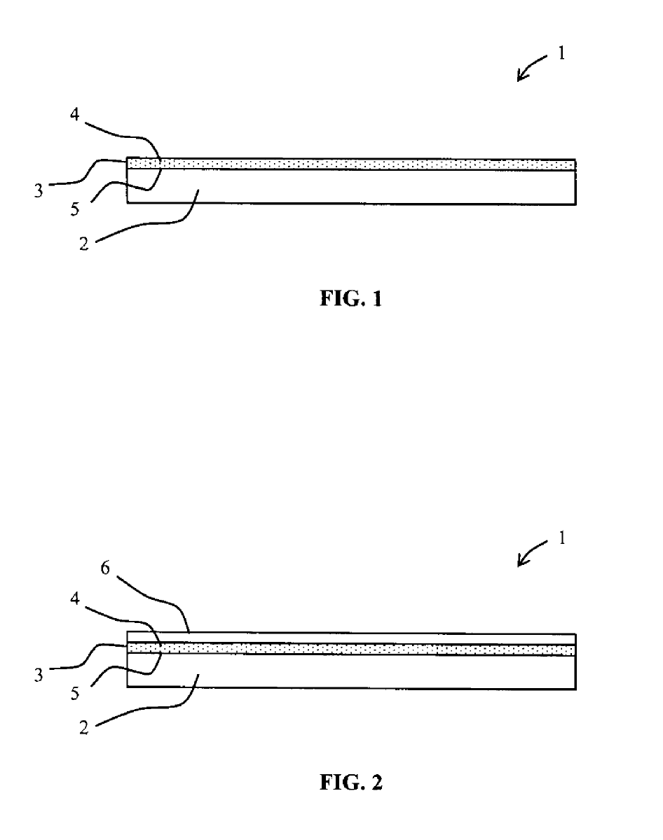

Figure shows a surface covering 1 according to an embodiment of the invention. The surface covering 1 shown and described herein is a resilient surface covering, which may be provided, for example, in the form of a tile or a continuous sheet. As shown in FIG. 1, the surface covering 1 comprises a base layer 2 and a wear layer 3. The wear layer 3 is provided with wear resistant particles 4 and is printed with an ink pattern 5 on a bottom surface thereof. It will be appreciated by those skilled in the art, however, that the surface covering 1 is not limited to the structure shown and described herein. For example, the surface covering 1 may comprise additional base layers, film layers, and/or a topcoat. Further, the thickness of the base layer 2 and the wear layer 3 may be varied depending on the desired characteristics of the surface covering 1,

In the embodiment shown and described herein, the base layer 2 has a thickness of about 35-170 mils and comprises a binder, a filler, and an optional pigment. The binder may be, for example, a polymeric resin, such as a vinyl resin, mixed with a plasticizer, stabilizer, and processing aids. The polymeric resin may include, for example, a homopolymer, copolymer, terpolymer or combinations thereof. The homopolymer may include, for example, polyvinyl chloride, polyvinyl acetate, polyvinyl propionate, polyvinyl butyrate, polymerized vinylidene chloride, polymerized acrylic acid, polymerized ethyl acrylate, polymerized methyl acrylate, polymerized propyl acrylate, polymerized butyl acrylate, polyethylene, polypropylene, or mixtures thereof. The copolymer may include, for example, polyvinyl chloride/polyvinyl acetate, vinylidene chloride/vinyl chloride, methyl methacrylate/vinyl chloride, methyl acrylate/eth acrylate, ethyl acrylate/butyl acrylate copolymer, ethylene propylene copolymers, ethylene styrene copolymers, or mixtures thereof. The terpolymers may include, for example, polyvinyl chloride/polyvinyl acetate/carbon monoxide, or polyvinyl chloride/polyvinyl ;Acetate/acrylic polymer, Alternatively, the binder may be, for example, a thermoplastic polyester resin including at least one recyclable or renewable component.

The plasticizer may include, for example, ester type plasticizers, such as orthophthalates, non-orthopthalates, phosphates, benzoates, modified benzoates, tartrates, sebacates, adipates, citrates, hexanoates, soyates, trimellitates, sulfonates, rubbery plasticizers, such as butadiene-styrene copolymer, butadiene-acrylonitrile copolymer, or ethylene vinyl acetate, or other materials which function as plasticizers, such as epoxidized drying oils, aromatic hydrocarbon condensates and, chlorinated paraffin's. Where certain flexible soft vinyl resins are used, such as polymers containing large proportions of ethyl acrylate, no plasticizer may be needed. The stabilizer may include, for example, a mixed metal stabilizer, such as a calcium-zinc composition. The processing aids may include, for example, hydrocarbon resins, polystyrene resins, impact modifiers, flow modifiers, or fusion promoters, such as acrylic copolymers or polyethylene oxide.

The filler may include, for example, an inorganic or organic material, such as calcium carbonate, magnesium carbonate, silica, diatomaceous earth, dolomite, clay, or mixtures thereof. The filler may be a recyclable or renewable material. The optional pigment may include, for example, titanium dioxide, iron oxides, phthalocyanine blue, phthalocyanine green, azo red, benzidene yellow, carbon black, or mixtures thereof.

The formulation of the base layer 2 contains, for example, about 5-80% weight of the binder, preferably about 10-60% weight of the binder, and more preferably about 15-35% weight of the binder. Additionally, the base layer 2 contains, for example, about 20-95% weight of the filler, preferably about 40-90% weight of the filler, and more preferably about 65-85% weight of the filler.

The wear layer 3 is a film consisting of a polymer binder system dispersed with the wear resistant particles 4. The wear layer 3 has a thickness of about 1-40 mils, preferably about 2-12 mils, and more preferably about 2--4 mils, The polymer binder system may comprise, for example, a polymeric resin mixed with an additive package and a plasticizer, In the preferred embodiment, the polymeric resin is a vinyl resin, such as polyvinyl chloride. Alternatively, the polymeric resin may be, for example, polyethyleneterephthalate (PET), glycolated polyethyleneterephthalate (PETG), polybutylene terephthalate (PBT), polypropylene terephthalate (PPT), or a thermoplastic ionomer resin, such as SURLYN from E. I. du Pont de Nemours and Company. The polymeric resin may also consist, for example, of recycled material, such as recycled polyethyleneterephthalate (PET) or polybutylene terephthalate (PBT) modified by renewable polyesters. The plasticizer may include, for example, unsaturated glycerides or phthalate esters.

For a polymer binder system comprising a vinyl resin, such as polyvinyl chloride, the additive package may include, for example, a stabilizer, a modifier, an acrylic processing aid, an internal and external lubricant package, an ultraviolet absorber, tint, other specialty additives, or any combination thereof, The stabilizer is present in the film, for example, at a level of about 0.7-3 parts per hundred parts by weight of the polymeric resin (phr) and may comprise for example, a thermal stabilizer, such as organo tin, calcium zinc, or other metallic salt. The modifier is present in the film, for example, at a level of about 4-15 parts per hundred parts by weight of the polymeric resin (phr) and may comprise, for example, an impact strength modifier, such as methylmethacrylate butadiene styrene (MBS), acrylonitrile butadiene styrene (ABS), or all-acrylic. The acrylic processing aid is present in the film, for example, at a level of about 1-3 parts per hundred parts by weight of the polymeric resin (phr). The internal and external lubricant package is present in the film, for example, at a level of about 0.2-1.5 parts per hundred parts by weight of the polymeric resin (phr) and may comprise, for example, glycerol monooleate, glycerides, or ester wax. The ultraviolet absorber is present in the film, for example, at a level of about 0-0.8 parts per hundred parts by weight of the polymeric resin (phr). The tint may include, for example, transparent or filled titanium dioxide opaque color tints or transparent clear tints.

In the preferred embodiment, the film is a rigid film, and more preferably a rigid vinyl film. A rigid film is known in the art as a film that is free of or substantially free of plasticizers, e.g., comprising less than 5 parts of the plasticizer per hundred parts by weight of the polymeric resin (phr). It will be appreciated by those skilled in the art, however, that the film may alternatively be a semi-rigid film or a flexible film. A semi-rigid film is defined herein as a film comprising 5-10 parts of the plasticizer per hundred parts by weight of the polymeric resin (phr). A flexible film is defined herein as a film comprising greater than 10 parts of the plasticizer per hundred parts by weight of the polymeric resin (phr).

The wear resistant particles 4 dispersed in the polymer binder system of the film are aluminum oxide (Al₂O₃). It will be appreciated by those skilled in the art, however, that alternatively or in addition to aluminum oxide, other wear resistant particles may be used, such as crystalline classes of silicon carbide, hard plastics, reinforced polymers, nylon, organics, or any combination thereof. The wear resistant particles 4 are nano-sized and may be in the range, for example, of about 10-500 nanometers, preferably 20-100 nanometers, and more preferably about 20-40 nanometers. The wear resistant particles 4 are dispersed at a level of about 0.1-5 parts per hundred parts by weight of the polymeric resin (phr), and more preferably about 0.5-1.5 parts per hundred parts by weight of the polymeric resin (phr).

In order to make the wear layer 3, the wear resistant particles 4 are first dispersed in a compatible liquid to form a stable liquid dispersion. The liquid may be, for example, a liquid component of the polymer binder system, such as the plasticizer or a liquid component of the additive package. The stable liquid dispersion is then blended in the polymeric resin and any remaining components of the polymer binder system using a high speed mixer to a temperature of about 60-90 degrees Celsius to form a mixture. The mixture containing the polymer binder system and the wear resistant particles 4 is thermally compressed, fused, and compounded and preferably extruded or continuously mixed to a temperature of about 160-200 degrees Celsius. The mixture is then preferably calendared to form the wear layer 3. For the wear layer 3, comprising the vinyl resin, the calendaring temperatures may range, for example, from about 190-225 degrees Celsius. Because the processes of blending, compounding, extruding, and calendaring a mixture to form a film is well known in the art, further description thereof has been omitted.

As shown in FIG. 1, after formation of the wear layer 3, the wear layer 3 is printed with the ink pattern 5. In the embodiment shown and described herein, the wear layer 3 is provided with the ink pattern 5 on a back surface thereof. It will be appreciated by those skilled in the art, however, that the wear layer 3 may alternatively be clear or provided with an ink pattern on a top surface thereof in addition to or as an alternative to providing the ink pattern 5 on the back surface. The wear layer 3 may also optionally be mechanically and/or chemically embossed. The wear layer 3 is then laminated to the base layer 2. The wear layer 3 may be laminated to the base layer 2, for example, using a conventional standard stack press or a conventional rolling nip-type laminator.

FIG. 2 shows an alternate embodiment of the invention. As shown in FIG. 2, the wear layer 3 is provided with a topcoat 6. The topcoat 6 is coated in a liquid or flowable form onto the wear layer 3 at a thickness of about 1 mil and then cured. It is known to cure the topcoat 6 by controlled exposure to radiation, such as ultraviolet or electron beam radiation. The topcoat 6 may be, for example, a radiation curable coating, such as an acrylated urethane or acrylated polyester. Alternatively, the topcoat (not shown) may be a radiation curable biobased coating comprising a biobased component. The biobased component may be, for example, a biobased polyol, acrylated biobased polyol, or biobased resin derived, for example, from renewable and/or biobased materials, such as plant oils, polyester, polyester-ether, vegetable oils, corn, cellulose, starch, sugar, or sugar alcohols. The topcoat 6 provides additional resistance to marking and scuffing to the outermost surface of the surface covering 1.

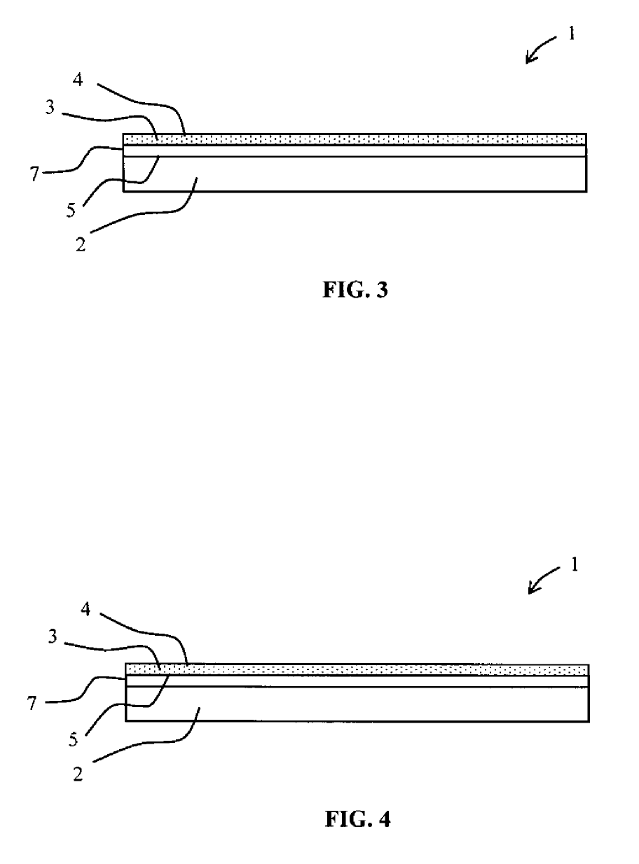

FIGS. 3-4 show a further alternate embodiment of the invention. As shown in FIGS. 3-4, the surface covering Inlay also be provided with a print layer 7. The print layer 7 may be, for example, a rigid film or semi-rigid film comprising, for example, a polymeric resin mixed with an additive package and a plasticizer. The polymer binder system may comprise, for example, a polymeric resin mixed with an additive package and a plasticizer. The polymeric resin may be, for example, a vinyl resin, such as polyvinyl chloride. Alternatively, the polymeric resin may be, for example, polyethyleneterephthalate (PET), glycolated polyethyleneterephthalate (PETG), polybutylene terephthalate (PBT), polypropylene terephthalate (PPT), or a thermoplastic ionomer resin, such as SURLYN from E. I. du Pont de Nemours and Company. The polymeric resin may also consist, for example, of recycled material, such as recycled polyethyleneterephthalate (PET) or polybutylene terephthalate (PBT) modified by renewable polyesters. The plasticizer may include, for example, unsaturated glycerides or phthalate esters. The additive package may include, for example, a stabilizer, a modifier, an acrylic processing aid, an internal and external lubricant package, an ultraviolet absorber, tint, other specialty additives, or any combination thereof.

In FIGS. 3-4, the print layer 7 is printed with the ink pattern 5 instead of the wear layer 3. In FIG. 3, the print layer 7 is provided with the ink pattern 5 on a back surface thereof. In FIG. 4, the print layer 7 is provided with the ink pattern 5 on a top surface thereof. It will be appreciated by those skilled in the art, however, that the print layer 7 may alternatively be dear or provided on both the back surface and the top surface of the print layer 7. The print layer 7 may also optionally be mechanically and/or chemically embossed. Additionally or alternatively, the wear layer 3 could also be provided with a print layer on a back surface and/or top surface thereof and/or could he mechanically and/or chemically embossed. Because printing and mechanical and chemical embossing print layers are well known in the art, further description thereof has been omitted.

The print layer 7 is laminated to the base layer 2 between the base layer 2 and the wear layer 3. The print layer 7 is laminated to the base layer 2 between the base layer 2 and the wear layer 3, for example, using a conventional standard stack press or a conventional rolling nip-type laminator.

In the surface covering 1 according to the embodiments of the invention described herein, the wear layer 3, which forms the outmost surface of the surface covering 1, is dispersed with the wear resistant particles 4, which provides the wear layer 3 with added abrasion and chemical resistance properties. The surface covering 1 according to the invention thereby can be easily constructed to have an outermost surface with added abrasion and chemical resistance properties while eliminating unnecessary processing steps and reducing costs.

The foregoing illustrates some of the possibilities for practicing the invention. Many other embodiments are possible within the scope and spirit of the invention. For example, although the wear layer 3, is shown and described herein as being used in conjunction with the surface coverings 1, which are related to flooring surfaces, it will be appreciated by those skilled in the art that the wear layer could be used in conjunction with other types of surface coverings, such as wall paper, countertops, automobile structures, furniture surfaces, protective case surfaces, and the like, and still exhibit the same added abrasion and chemical resistance properties. It is, therefore, intended that the foregoing description be regarded as illustrative rather than limiting, and that the scope of the invention is given by the appended claims together with their full range of equivalents.

1. A surface covering comprising a first major surface opposite a second major surface, the surface covering further comprising a laminate structure comprising:
a base layer;
a wear layer atop the base layer, the wear layer having a first thickness as measured from an upper surface to a lower surface of the wear layer, the wear layer comprising a polymeric binder and wear resistance particles dispersed in the polymer binder;
a topcoat layer atop the wear layer, the topcoat layer having a second thickness as measured from an upper surface to a lower surface of the topcoat layer; and
wherein the wear resistance particles are offset from the first major surface of the surface covering by a distance of at least the second thickness of the topcoat layer.

2. The surface covering of claim 1, wherein the first major surface of the surface covering comprises the upper surface of the topcoat layer.

3. The surface covering of claim 1, wherein the topcoat layer is continuous.

4. The surface covering of claim 1, wherein the ratio of second thickness to the first thickness ranges from about 1:1 to about 1:40.

5. The surface covering of claim 4, wherein the ratio of second thickness to first thickness ranges from about 1:1 to about 1:12.

6. The surface covering of claim 1, wherein the ratio of the second thickness of the topcoat layer to a size of wear resistant particles ranges from about 2500:1 to about 50:1.

7. The surface covering of claim 1, wherein the laminate structure further comprises a print layer positioned between the base layer and the wear layer.

8. The surface covering of claim 7, wherein the print layer is embossed.

9. The surface covering of claim 1, wherein the wear resistance particles have a size ranging from about 10 nm to about 500 nm.

10. The surface covering of claim 1, wherein the wear resistance particles are present in an amount of 0.1 parts to 5 parts per hundred parts by weight of the polymer binder in the wear layer.

11. The surface covering of claim 1, wherein the base layer has a third thickness as measured from an upper surface to a lower surface of the base layer, the third thickness ranging from about 35 mils to 170 mils.

12. The surface covering of claim 1, wherein the first thickness of the wear layer ranges from about 1 mil to about 40 mils.

13. A process for forming a surface covering comprising:
mixing together polymeric binder and wear resistant particles to form a wear composition;
forming a film from the wear composition; and
applying the film to a base layer;
wherein the film is formed by at least one of extruding or calendering the wear composition into the film.

14. The process of claim 13, wherein the film is applied to the base layer by stack press or rolling laminator.

15. The process of claim 13, wherein the film is formed by calendering the wear composition, and the film has a thickness ranging from about 1 mil to 40 mils.

16. The process of claim 13, wherein the film is formed by calendering the wear composition at a temperature ranging from about 160° C. to about 200° C. and the polymeric binder of wear composition comprises vinyl resin.

17. The process of claim 13, wherein the base layer comprises an upper surface opposite a lower surface, the upper surface comprising a decorative pattern, wherein the film is applied to the upper surface of the base layer and the film is clear.

18. The process of claim 13, further comprising forming a topcoat atop the film.

19. The process of claim 18, wherein the topcoat is formed by applying a topcoat composition that comprises a curable polymeric composition and curing the topcoat composition by at least one of UV radiation or electron beam radiation.

20. A surface covering comprising a laminate structure comprising:
a base layer having an upper surface opposite a lower surface;
a wear layer atop the base layer, the wear layer comprising a polymeric binder and wear resistance particles; and
a topcoat layer atop the wear layer, the topcoat layer being a continuous layer and being substantially free of the wear resistant particles.
